(19) United States
(12) Patent Application Publication
(10) Pub. No.: US 2002/0004731 A1
(43) Pub. Date: Jan. 10, 2002

(54) Omega insurance claims settlement system

(76) Inventor: Martyn George Belben, Fort Lauderdale, FL (US)

Correspondence Address: Omega Two Thousand System Corp., P. O. Box 4647, Fort Lauderdale, FL, 33338, US

(21) Appl. No.: 09/835,959

(22) Filed: Apr. 16, 2001

Related U.S. Application Data
(60) Provisional application No. 60/198,428, filed on Apr. 19, 2000.

(51) Int. Cl. G06F 17/60

(52) U.S. Cl. 705/4

(57) ABSTRACT

An insurance claims settlement system by which settlement of insurance claims may be made more efficient, less costly to administer and maintain, making immediate settlement of insurance claims possible, which reduces the possibility of fraud and/or forgery, in a paperless environment in line with current technology and commercial practice.

### CROSS-REFERENCE TO RELATED APPLICATIONS

Provisional Patent Application JC541 U.S. PTO 60/198428 Apr. 19, 2000. Amendment to convert to RPA attached.

### RESEARCH AND DEVELOPMENT

Not applicable

### BACKGROUND

1. Field of Invention

This invention relates to the settlement of insurance claims by insurance companies, insurance underwriters and other insuring entities, either directly to insured(s) and/or claimants, or through insurance agents, insurance brokers or intermediaries.

2. Description of Prior Art

Insurance claims of every type and description currently are settled by insurance companies, insurance underwriters and other insuring entities, often through insurance agents, insurance brokers or intermediaries, by the issue of a paper check drawn on a commercial bank. Said check is then mailed or delivered personally to the payee or a representative of the payee or payees to whom settlement is made.

(a) The insurance claims settlement system currently in use universally, world wide, is expensive to operate and maintain, is labor intensive and involves a degree of paper usage incompatible with modern standards of conducting commercial business.

(b) Insuring entities, agents, brokers and other intermediaries who have adopted a paperless administrative environment, continue to use the paper check method of settling claims.

(c) Claims departments of all insuring entities, and/or their agents, brokers or intermediaries are non-revenue earning, administrative departments which have a negative impact on overheads.

(d) The paper check method of settling insurance claims creates a medium for forgery and/or fraud.

(e) The paper check method of settling insurance claims is time consuming, and often generates additional delays in effecting claims settlements resulting from administration and/or security and/or authorization considerations which every insuring entity, or their agents, brokers or intermediaries have in place as a matter of corporate policy.

(f) The paper check method of settling an insurance claim by mailing a paper check to a payee, payees or a representative of a payee or payees is in and of itself a time consuming factor. This adversely contributes to and escalates the inefficiency of the system.

(g) The paper check method of settling an insurance claim by a representative of the insuring entity delivering personally said check to a payee or a representative of a payee or payees, is disproportionately expensive in terms of the expenditure of man hours and other resources.

(h) The paper check system of settling insurance claims involves additional time delays in effecting actual settlement when paper checks are required to be endorsed by mortgagees and other lien holders, before a payee or payees may receive value for the paper check settlement.

### SUMMARY

In accordance with the present invention, an insurance claims settlement system is established by which insurance claims are settled via wired data communications media, or via wireless data communications media.

### OBJECTS AND ADVANTAGES

Accordingly, several objects and advantages of the present invention are:

(a) to provide an insurance claims settlement system which reduces administration costs and which is more in line with current technology and commercial practice;

(b) to provide an insurance claims settlement system which, by reducing the costs of claims administration, impacts positively on day-to-day operations and overheads for insuring entities and others involved in insurance claims settlements;

(c) to provide an insurance claims settlement system which reduces the possibility of fraud and/or forgery;

(d) to provide an insurance claims settlement system which reduces the time delay factor endemic to the mailed paper check settlement system currently in use;

(e) to provide an insurance claims settlement system which reduces costs incurred when paper checks are delivered personally by a representative of the insuring entity to a payee or a representative of a payee or payees;

(f) to provide an insurance claims settlement system which is more convenient to an insured or claimant receiving settlement, by making settlement funds available immediately;

(g) to provide an insurance claims settlement system which will reduce time delays by eliminating the necessity of obtaining physical endorsements of paper checks by mortgagees and other lien holders.

Further objects and advantages are to provide an insurance claims settlement system which may be accessed and operated as easily in the field as in the office environment; to provide a capability, within specified and predetermined criteria, which may be accessed and operated by supervisors and other managers from any location, either by wired or wireless communications media; and to establish a more efficient, user friendly insurance claims settlement system.

### DRAWING FIGURES

Not applicable.

### REFERENCE NUMERALS IN DRAWINGS

Not applicable.

### DESCRIPTION

An insurance claims settlement system which:

(a) an insurance company and/or reinsurance company and/or self insurer and/or insurance underwriter and/or insurance underwriting syndicate(s) and/or insurance broker(s) and/or intermediary(ies), or any combination thereof, and/or any representative acting for or on behalf thereof, hereinafter insurer(s)

(b) makes settlement of an insurance claim and/or insurance claims and/or makes other payment(s),

(c) to an insured(s) and/or mortgagee(s) and/or lienholder(s) and/or claimant(s) and/or any combination thereof and/or any other person or entity authorized to accept settlement funds, hereinafter payee(s),

(d) by said insurer(s) establishing an account in the name(s) of the payee(s) with a management company, commercial bank, credit/debit card company or any other entity issuing debit cards;

(e) by crediting such account with an amount equal to the amount of said settlement(s) and/or payment(s);

(f) and by issuing and/or causing to be issued to the payee(s) a debit card or debit cards linked to the account established by or on behalf of insurer(s) in the name(s) of the payee(s),

(g) by which settlement funds are made available immediately to the payee(s).

### OPERATION

The system uses existing commercial financial institution computer software technology currently in common usage by commercial banks and credit/debit card companies, with minor modifications. Such modifications could be made by a computer software programmer of average ability familiar with financial institution computer software.

An insurer utilizing the system will be issued an identification number which will be exclusive to that company. This number could include a branch identification number if desired.

Each official of the insurer who is authorized to settle insurance claims shall be issued a personal identification number, exclusive to that official. Such official shall also be issued a specific monetary limit of settlement authority, applicable to any one settlement or transaction.

In order to effect settlement of an insurance claim, the official of the insurer effecting the settlement shall open an account in the name of the payee(s) with the system's operating company or commercial bank.

The official shall create a credit balance in the payee(s) account in the amount of the settlement to be made, using his/her PIN as his/her settlement authority, within his/her predetermined monetary authority limit(s).

The official shall issue, or cause to be issued, to the payee(s) a debit card for use by the payee(s) to gain access to the funds which comprise the settlement. This debit card will contain a number exclusive to the insured or insureds, payee or payees to whom settlement is made.

Prior to having access to the account established in their name(s) the payee(s) shall apply for and be issued a personal identification number, exclusive to that/those payee(s), by the financial institution with whom the account has been opened and the credit established.

Access to the funds shall thereafter be made available to the payee(s) as with any debit card system currently in use.

Any authorized official who seeks to effect a settlement which exceeds his monetary settlement authority, shall have that transaction placed on hold, disallowing access temporarily to that account by the payee(s). The temporary hold on the account would be released by a supervisor or manager with sufficient monetary settlement authority, by using his/her exclusive personal identification number as his/her confirmation and authorization of the settlement.

A mortgagee or other lienholder utilizing the system shall be issued an account number which shall be exclusive to that entity. This number could incorporate a branch number if desired.

Each official of such mortgagee or other lienholder who is authorized to release funds to a borrower and/or customer shall have issued to him a personal identification number, exclusive to that individual. Such personal identification number shall be used to release funds to a borrower when a settlement to an account includes the name of such mortgagee or other lienholder.

### CONCLUSION, RAMIFICATION AND SCOPE

Accordingly, the reader will see that this invention has multiple advantages over the existing paper check system of settling insurance claims.

By application of the system the settlement of insurance claims becomes more convenient for both insurer(s) and payee(s) in that

(a) it establishes an insurance claims settlement system which is more in line with current technology and commercial practice; and

(b) it reduces man hours by streamlining the steps necessary to effect settlement of an insurance claim, thereby making the entire process more efficient and cost effective, and

(c) it reduces the possibility of fraud and/or forgery endemic to the current paper check settlement system; and

(d) it reduces the time delay factors endemic to the current paper check settlement system; and

(e) it makes immediate settlements of insurance claims possible which are unachievable using the current paper check claims settlement system.

Although the description above contains many specificities, these should not be construed as limiting the scope of the invention but as merely providing illustrations of some of the presently preferred embodiments of this invention. For example, the system could be used to by a financial institution to make funds available immediately to a customer who is at another location, who might be unable to receive and/or negotiate a paper check settlement.

Thus, the scope of the invention should be determined by the appended claims and their legal equivalents, rather than by the examples given.

I/we claim:

1. A method of settling an insurance claim by:
(a) the insurer or any entity acting for or on behalf of the insurer establishing an account in the name or names of its insured or insureds or other payee or payees with a management company, commercial bank or other financial institution;
(a) the insurer or any entity acting for or on behalf of the insurer creating or causing to be created a credit to the account established in the name or names of its insured or insureds or other payee or payees, such credit being equal to the amount of the settlement being made;
(b) the insurer or any entity acting for or on behalf of the insurer issues or causes to be issued to its insured or insureds, or other payee or payees a debit card linked to the account established by the insurer or on its behalf in the name or names of its insured or insureds, or other payee or payees;
(d) the insurer or any entity acting for or on behalf of the insurer releases or causes to be released, or otherwise activates or causes to be activated the account established in the name or names of its insured or insureds, or other payee or payees thereby providing access to the settlement funds by its insured or insureds, or other payee or payees.
